(19) United States
(12) Patent Application Publication
(10) Pub. No.: US 2022/0122072 A1
(43) Pub. Date: Apr. 21, 2022

(54) SYSTEMS AND METHODS FOR SECURE REDEMPTION OF ELECTRONIC TICKETS USING BLOCKCHAIN PROTOCOLS

(71) Applicant: YellowHeart LLC, New York, NY (US)

(72) Inventors: Jimmy C. Kang, Warren, NJ (US); Evan Kress Frohlich, Astoria, NY (US); Joshua Katz, New York, NY (US)

(21) Appl. No.: 17/337,208

(22) Filed: Jun. 2, 2021

Related U.S. Application Data
(60) Provisional application No. 63/034,382, filed on Jun. 3, 2020.

(51) Int. Cl. G06Q 20/40; G06Q 20/32

(52) U.S. Cl. CPC G06Q 20/401; G06Q 20/3276

(57) ABSTRACT

Various embodiments of the present disclosure relate generally to systems and methods for secure redemption of electronic tickets. In an exemplary embodiment, secure redemption of electronic tickets may be achieved using a unique dynamic QR barcode that is encoded with information identifying a specific customer. In an exemplary embodiment, secure redemption of electronic tickets may be achieved using a distributed system with blockchain protocols and smart contracts. More specifically, particular embodiments of the present disclosure relate to systems and methods for creating a blockchain-based online ticketing platform that is fully decentralized, completely public, and may be entirely transparent to a buyer and/or a seller of live event tickets (e.g., sporting events, concerts, theatrical productions, and other live entertainment events).

### CROSS-REFERENCE TO RELATED APPLICATION

The present application claims the benefit of priority under 35 U.S.C. § 119(e) to U.S. Provisional Patent Application No. 63/034,382, filed on Jun. 3, 2020, the disclosure of which is incorporated by reference herein in its entirety.

### TECHNICAL FIELD

The present disclosure relates aspects of an online platform in a distributed system with blockchain protocols and smart contracts for buying, selling, and redeeming and/or using authenticated digital live event tickets. The online platform may be decentralized, may have the ability to provide improved security and authentication against counterfeiting, may have the ability to control a transaction(s) end-to-end, may have the ability to regulate or control participant activity on the platform, and may have the ability to recapture revenue from sales of the authenticated digital live event tickets on primary and/or secondary markets.

Various embodiments of the present disclosure relate generally to systems and methods for secure redemption of electronic tickets. In an exemplary embodiment, secure redemption of electronic tickets may be achieved using a unique dynamic QR barcode that is encoded with information identifying a specific customer. In an exemplary embodiment, secure redemption of electronic tickets may be achieved using a distributed system with blockchain protocols and smart contracts. More specifically, particular embodiments of the present disclosure relate to systems and methods for creating a blockchain-based online ticketing platform that is fully decentralized, completely public, and may be entirely transparent to a buyer and/or a seller of live event tickets (e.g., sporting events, concerts, theatrical productions, and other live entertainment events).

The present disclosure also relates generally to systems and methods for using a distributed ledger (e.g., fully decentralized blockchain, partially decentralized blockchain, etc.) to create an online platform for the buying and/or selling of authenticated digital assets. In an exemplary embodiment, and as taught throughout this disclosure, the online platform is an online ticketing platform for the commerce (e.g., buying, selling, transferring, etc.) of authenticated live event tickets. In an exemplary embodiment, systems and methods for using a distributed ledger (e.g., fully decentralized blockchain, partially decentralized blockchain, etc.) for commerce with blockchain protocols and smart contracts are disclosed, and include the ability to control end-to-end commerce so that revenue on primary and/or secondary markets may be recaptured and distributed in a controlled and orderly manner (e.g., controlled by a rule set or rule sets) to different participants in a commercial transaction, a private transaction, a peer-to-peer transaction, or a machine-to-machine transaction.

### BACKGROUND

The live event ticket industry engages in tens of billions of dollars in transactions each year. Examples of live events requiring a ticket include, but are not limited to, sporting events, concerts, theatrical productions, and other live entertainment events. Online ticket exchanges proliferate the Internet with exchanges to buy and/or sell event tickets for these live events. In many instances, these live event tickets are presented in electronic format, and may be referred to as an “e-ticket”. However, most e-tickets today are delivered as PDF documents containing a barcode scanned at the event's point of entry. This e-ticketing process can be easily copied and is not secure. Some in the industry are attempting to make this e-ticketing redemption process more secure. For example, some e-ticketing processes may utilize a process with built-in security where the security is based on random seeds and/or shared keys; however, these attempts are not secure because the keys are shared and random seeds must be transmitted to the application at or before barcode generation time. In this solution, however, the random seeds must also be stored in a centralized server, making them vulnerable to theft via hacking.

Most tickets today are delivered as PDF documents containing a barcode such as a QR code that is scanned at the event's point of entry. These tickets can be printed out onto paper prior to going to the event and then scanned at the entrance to the event. Alternatively, these tickets can reside in electronic format as an image on the users mobile phone, which can be scanned at the entrance to the event. This is subject to security and authentication issues. Such tickets can easily be manually or digitally copied and sent to other users besides the actual ticket holder.

Some presently available systems may include some level of security based on random seeds and shared keys. However, this is likewise relatively easy to circumvent by copying and is therefore not secure. For example, one prior art system employs an encrypted rotating barcode in a mobile app. This system generates an electronic barcode using a random value seed and encryption keys that are shared for all users or unique only to a specific ticket. However, this system is far less secure than the present invention. This is because the seeds are analogous to passwords and do not offer verification of ownership. Thus, the seeds may be obtained surreptitiously from the application and then applied to ticket codes to generate valid QR's.

Therefore, a need exists to create an authenticated, public, secure online ticketing platform with secure redemption of electronic tickets (e.g., live event tickets) that may be achieved using a distributed system with blockchain protocols and smart contracts.

A need also exists for systems and methods that provide the ability to redeem digital tickets used to allow ticket holders to access the event venue in a secure and authenticated manner such that they are extremely difficult to forge, thus preventing unauthorized access and/or fraud.

There is also a need to ensure that when the tickets are redeemed by the user, that this is done in a secure and authenticated manner and where tickets are tied specifically to a defined (e.g., specific) customer.

### SUMMARY

Embodiments of the present disclosure relate to, among other things, systems and methods for using a distributed ledger (e.g., blockchain) to create an online ticket platform for the buying and/or selling of authenticated live event tickets. More specifically, particular embodiments of the present disclosure relate to systems and methods for creating a blockchain-based online ticketing platform that is decentralized, completely public, and may be entirely transparent to a buyer and/or seller of live event tickets (e.g., sporting events, concerts, theatrical productions, and other live entertainment events).

Currently, most ticket lifecycles cannot reliably know the owner of the ticket at time of redemption. Embodiments of the present disclosure relate to public electronic ticketing platforms that may utilize fully or partially de-centralized blockchains, as described above, for the secure redemption of electronic tickets to be purchased, sold, exchanged, licensed, or otherwise disposed on the platform.

Aspects of the present disclosure taught herein are directed to bolstering ticket redemption security using blockchain-based protocols. Embodiments of the present disclosure relate to improving secure electronic ticket redemption using cryptographic digital signatures with users having unique key pairs; rotating barcode(s) with rapid expiration to mitigate sharing with screenshots. (e.g. a QR code expires before it can be screenshot and transferred to another user); and identification of redeeming users.

### BRIEF DESCRIPTION OF THE DRAWINGS

The various aspects described herein, both as to organization and methods of operation, together with further objects and advantages thereof, may best be understood by reference to the following description, taken in conjunction with the accompanying drawings as follows.

FIG. 1 is a flow diagram of an exemplary process for the secure redemption of electronic tickets using blockchain protocols, in accordance with at least one aspect of the present disclosure.

FIG. 2 is a block diagram depicting details of the exemplary process shown in FIG. 1.

FIG. 3 is an exemplary user interface on an exemplary user device in accordance with at least one aspect of the present disclosure, wherein the exemplary user interface employs the exemplary process shown in FIGS. 1 and 2.

### DETAILED DESCRIPTION

While the present disclosure is described herein with reference to illustrative embodiments for particular applications, it should be understood that embodiments of the present disclosure are not limited thereto. Other embodiments are possible, and modifications can be made to the described embodiments within the spirit and scope of the teachings herein, as they may be applied to the above-noted field of the present disclosure or to any additional fields in which such embodiments would be of significant utility. For example, embodiments described herein can be used with any good and/or service that can be represented digitally.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

These embodiments, which are also referred to herein as “examples,” are described in enough detail to enable those skilled in the art to practice the invention. The embodiments may be combined, other embodiments may be utilized, or structural, logical and/or electrical circuitry changes may be made, without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, patent documents, whitepapers, and technical papers referred to in this document or in the attached appendices are incorporated by reference in their entirety herein, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

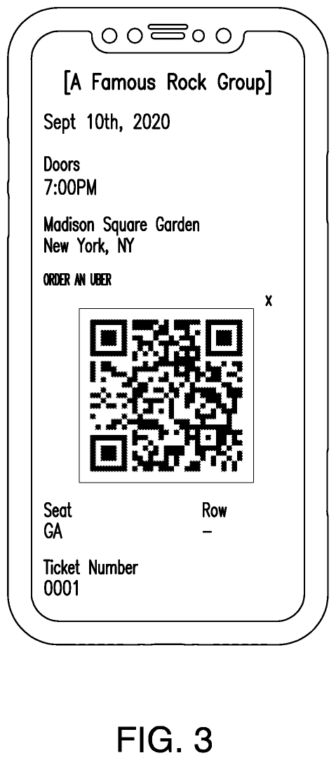

The present disclosure relates to an online platform for commerce in a distributed system with blockchain protocols and smart contracts. In an embodiment, “online” may refer to any online platform controlled by or connected to another computer or to a network, and that may be accessed or controlled by a device, shown in FIG. 3, (e.g., laptop, smartphone, desktop computer, tablet, or any device with network access. In one embodiment, the online platform may be configured to operate over an Internet-of-Things (e.g., an interconnection via the Internet of computing devices embedded in everyday objects, enabling them to send and receive data).

Various embodiments of the present disclosure relate generally to systems and methods for using a distributed ledger (e.g., fully decentralized blockchain, partially decentralized blockchain, etc.) to create an online platform for the buying, selling, and/or redemption of collectibles (e.g., electronic live event tickets). In an exemplary embodiment, the online platform is an online ticketing platform for the commerce (e.g., buying, selling, transferring, secure ticket redemption etc.) of authenticated live event tickets.

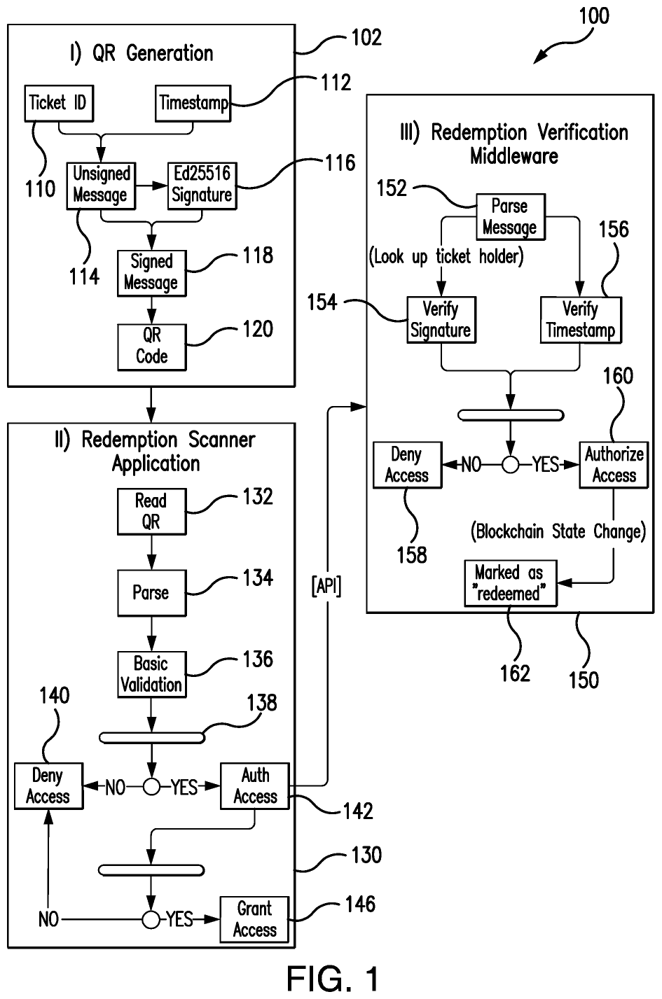

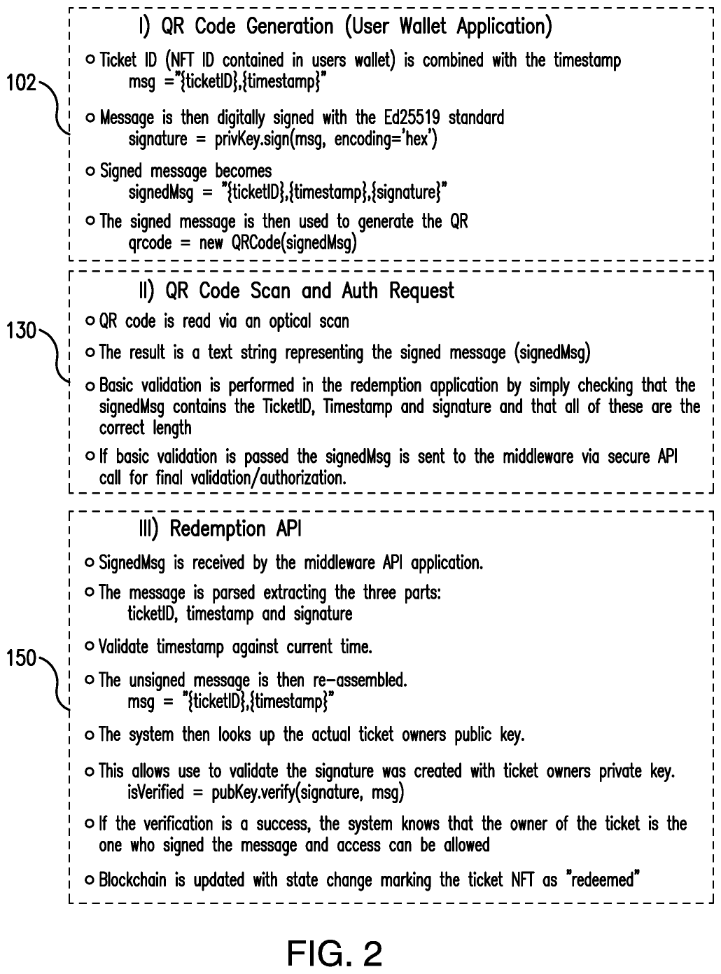

In an exemplary embodiment, and according to aspects of the present disclosure, secure redemption of electronic tickets may be achieved using a distributed system with blockchain protocols and smart contracts, as taught herein, and as depicted in FIGS. 1 and 2. More specifically, particular embodiments of the present disclosure relate to systems and methods for creating a blockchain-based online ticketing platform that is fully decentralized, completely public, and may be entirely transparent to a buyer and/or a seller of live event tickets (e.g., sporting events, concerts, theatrical productions, and other live entertainment events).

As previously described, benefits of the platform(s) described herein for the secure redemption of electronic tickets include: cryptographic digital signatures with users' unique key pairs; a rotating barcode with rapid expiration to mitigate sharing with screenshots (e.g. a QR code expires before it can be screenshot and transferred to another user); and identification of redeeming users. Currently, most ticket lifecycles cannot reliably know the owner of the ticket at time of redemption.

The present disclosure describes systems and methods that can securely and reliably identify the owner of the ticket at the time of electronic ticket redemption. In an exemplary embodiment, Ticket Redemption QR codes may be used to allow ticket holders to access the event venue. These QR codes must be impossible or extremely difficult to forge to prevent unauthorized access and/or fraud.

Embodiments of the present disclosure present several advantages in the secure redemption of an electronic ticket (e.g., scanning a ticket redemption QR code to gain entry to a live event that requires a ticket). For example, embodiments of the present disclosure present systems and methods that may permit the online platform, as taught herein, or another party, to confirm who (e.g., what specific person) is in a seat at a specific live event (e.g., shows, concerts, sporting event, theater production, etc.) and not just the purchaser of the electronic ticket for that specific live event. Another benefit may include the use of a rotating QR code (i.e., a QR code that dynamically and continuously changes to a different QR code at a specified time interval), on which public and/or private key(s) (e.g., a private key may correspond to a specific user or owner) may be encoded onto said rotating QR code. In an exemplary embodiment, the public and/or private key(s) may be encoded into the QR code as a timestamp. The QR code may update at a predetermined interval, for example, every five seconds, or ten seconds, etc. In an exemplary embodiment, embedding the user's unique key (e.g., private key) into the QR code may be performed or executed as a “signed message”, which would assist in confirming the user is owner of the electronic ticket and is the true user/owner that is eligible for redeeming that electronic ticket (e.g., to gain access to the live event for which that ticket was purchased). In an exemplary embodiment, the QR code may be dynamic and may be generated and “signed” by public/private key code(s) In this regard, the online platform, as taught herein, may check or verify if the holder of the electronic ticket is the person who signed it. During redemption of the electronic ticket (e.g., when the QR code of the e-ticket is scanned to permit entry into a live event), an inverse decoding process may be conducted. For example, in an one embodiment, at scanning, the inverse decode may be performed on the QR bar code to extract the information related to the electronic ticket event and the “signature” of a unique user (e.g., true owner of the electronic ticket so that owner can properly and securely redeem the ticket). In an exemplary embodiment, the unique user may be verified or checked by looking up a record of purchase on the blockchain of the online platform taught, as taught herein.

In an exemplary embodiment, and according to aspects of the present disclosure, the electronic live event ticket, as taught herein, may be redeemed as a QR code, which may be referred to as a Ticket Redemption QR code system throughout this disclosure. A QR code system may include a barcode that is a machine-readable optical label that contains information about the item to which it is attached, for example, information related to a live event ticket. In practice, QR codes may contain data for a locator, identifier, or tracker that points to a website or application. A QR code may utilize four standardized encoding modes (numeric, alphanumeric, byte/binary, and kanji) to store data efficiently. In some case, extensions may be used. Embodiments taught herein may utilize one or more of these described QR code features.

In an exemplary embodiment, the Ticket Redemption QR code system may rely on cryptographic digital signatures with unique user key pairs to secure a ticket redemption QR code. Key pairs may include public keys and/or private keys. For example, public-key cryptography, or asymmetric cryptography, is a cryptographic system that uses pairs of keys: public keys, which may be disseminated widely, and private keys, which are known only to the owner (e.g., the user of the device, owner of the device, owner of the digital electronic ticket, owner of the digital wallet on which the digital electronic ticket is stored, etc.).

In an exemplary embodiment, one or more key pairs controlled by the ticket holder may be used to “sign” ticket data. Specifically, the private key may be used to create a signature which may be included along with the original message. In doing so, this may allow or permit verification that the signer of the message and the ticket holder are one and the same. Since the signing private key is stored on the ticket holder's device, no network connection is required. In an exemplary embodiment, to make the system dynamic, a timestamp may be added at the time of signing. This data may then be encoded as a standard QR code and regenerated on a set interval so that they are never the same twice.

In an exemplary embodiment, and according to aspects of the present disclosure, when designing the Ticket Redemption QR code system taught herein, one or more of the following high-level requirements may be desirable:
a. Unforgeable; fraud prevention;
b. Not usable when screen captured;
c. Dynamic;
d. Ever changing;
e. Does not require network access or communication with external systems to generate; and
f. Code should act as a proof of ownership, meaning that it could only be generated by the ticket holder.

In order to help satisfy the above requirements, the systems and methods described herein may use the Ed25519 public-key signature system.

When the ticket holder presents the QR code at time of redemption it is scanned, and the data is read out and may be parsed into its component parts, including the ticket ID that corresponds to the electronic ticket, the timestamp used to encode the QR code at the time of its creation, and the user's signature. Middleware (e.g., proprietary software particular to the online platform taught herein) may be used to check the validity of the message. At a first step, the system or platform may look up the electronic ticket in question on the blockchain and may then determine its owner's public key from the system or platform's records. In an exemplary embodiment, the system or platform may then be configured to use that public key to verify that the message was generated using the matching private key that only the true ticket holder has access to. In an subsequent step, the system or platform taught herein may be configured to then check the timestamp to ensure that the message was generated within a specified time range; and, thus, could not have been shared. Once verification is complete, the ticket holder is then granted access to the event venue.

In an exemplary embodiment, the system or platform described herein prevents use of a screen captured image or use of a static image. This is accomplished not by physically preventing screen capture, but by rendering the use of such screen captured images useless for ticket redemption, according to an aspect of the present disclosure. Specifically, the QR code of this embodiment is “rotating,” i.e., it dynamically changes to different QR codes at specific time-intervals, such as every few seconds. This cannot be copied by use of a static screen captured QR code. Because QR generation is dynamic and rotating (i.e., QR codes may be regenerated every few seconds) and contain the current timestamp, they may be easily invalidated at scanning (i.e., time of redemption).

In an exemplary embodiment, the middleware, as taught herein, may be loaded on a device that is reading the ticket. For example, in an exemplary embodiment, the YellowHeart Middleware is an API that provides authentication services to the redemption application. Therefore, a redemption scanner app, as shown in the flow diagram of FIG. 1, and in the corresponding description in FIG. 2, may then be able to submit scanned QR codes to the Middleware for authentication. The described system components are comprised of the user facing application for QR generation, redemption application and middleware, as shown in FIG. 1.

In an exemplary embodiment, the state change for the ticket may be recorded on the blockchain, as shown in FIG. 1 and described in FIG. 2. For example, when the QR code corresponding to that particular ticket is presented for redemption, decoded and verified by the middleware, the blockchain is updated to reflect that the ticket is now redeemed. This prevents any future use of that ticket for purposes of gaining entry, and provides a ledger record that the ticket has been used. Other information such as time of use, venue, or other information regarding redemption may also be recorded on the blockchain, along with changing the ticket status to indicate it has been redeemed.

With continuing reference to FIGS. 1 and 2, in order to generate a QR code, the ticket ID is concatenated with the timestamp so that it becomes a single string in the form of “{TicketID},{Timestamp}”. In an exemplary embodiment, the signed message is then used to generate the QR code (i.e., what the function QRCode(signedMsg) is doing to generate a new QR Code) by taking the original message “{TicketID},{Timestamp}” and further concatenating “{Signature}” in the form of “{TicketID},{Timestamp},{Signature}” as a single string (signedMsq). This concatenated string is then used to generate the QR code using well-known QR code generation techniques. When a user presents a QR code in order to redeem a ticket, the steps shown for the redemption API are performed. The message may then be parsed into its three constituent components: ticket ID, timestamp, and signature. In an exemplary embodiment, once the QR code has been scanned and read, the “signedMsg” is produced. The “signedMsg” may be in three exemplary parts, for example, in the string: “0x186A52020202020313030202020203,1589807495,BgK15Zuygsq07TkD/jptOvL116 DaZZI98wGevwWLOzpJBPSIkK1QegxDS/K+HpFU7Nuifu0t+eww/NCB83ODw==”, part 1 is the ticket ID of 0x186A52020202020313030202020203, part 2 is the timestamp of 1589807495, and part 3 is the signature of BgK15Z0uygsq07TkD/jptOvLII6DaZZI98wGevwWLOzpJBPSIkK1QegxDS/K+HpFU7Nui fu0t+eww/NCB83ODw==. The string is split at each comma to form the three parts.

In an exemplary embodiment, when the timestamp is validated against a current time, the validation may refer to taking the timestamp part from the “signedMsg” described above and compare it with a server time in UTC. If the timestamp is older or newer, then the message may be able to become invalidated. In an exemplary embodiment, the system taught herein knows or may identify who “owns” the non-fungible token (i.e., ticket) as it is in the user's digital wallet on the blockchain platform taught herein. In such an example, to look up the actual ticket owner's pubic key, the system queries the blockchain using the command “ownOf({TicketId})”. In an exemplary embodiment, and during operation, when a user “redeems” his/her non-fungible token (e.g., ticket), the system may conduct a simple blockchain transaction that changes the state of the ticket from “purchased” to “redeemed”. Again, during exemplary operation, once the ticket is redeemed, it cannot be redeemed again, as with a paper ticket redemption process.

In some embodiments, the electronic ticket (e.g., digital asset) may be referred to as a non-fungible token, and may be populated in an exemplary digital wallet belonging to a specific user (e.g., digital ticket wallet stored on a user's smartphone). The electronic ticket, which exists as a non-fungible token, corresponds to a specific individual live event ticket. The exemplary digital wallet may refer to a software component which may store cryptographic key pairs and may be used to interact with smart contracts for tracking ownership, transferring, buying and selling of digital tokens (e.g., ERC-721 non-fungible tokens).

The term “non-fungible” token, as used herein, may refer to and represent a live event ticket that has been tokenized, as taught herein. Non-fungible tokens may refer to actual ticket seats at a live event. For example, a non-fungible token may refer to a seat in a specific section of a stadium or arena, having a specific row and seat number, and valid for only that date. Non-fungible tokens are designated for a specific event instance and seat assignment. Non-fungible tokens are never the same, and each non-fungible token is distinct from other non-fungible token. For example, a non-fungible token to “Event A on Dec. 20, 2019, Section 102, Row 4” is unique to that event and that seat; a duplicate non-fungible token to that event and that seat does not exist since no two non-fungible tokens are the same. In an exemplary embodiment, a rule set may be created by the event originators to control the sale, purchase, transfer, etc. of the non-fungible token by the event originator. In an exemplary embodiment, the event originator can be the original artist, the promoter, the production company, the producer, and/or some related party tasked with creation of a live ticketing event.

Non-fungible tokens, as taught throughout this disclosure, are governed in the platform taught herein by “smart contracts.” See, for example, Ethereum White Paper: https://github.com/ethereum/wiki/wiki/White-Paper/f18902f4e7fb21dc92b37e8a0963eec4b3f4793a. A “smart contract”, as taught herein, is the basic immutable rule set and defines the fundamentals of what that token is and its properties and rules for how it may interact with a fully or a partially de-centralized blockchain. For example, ERC-721 and ERC-20 are examples of contracts that may be used an immutable rule set to define the properties of the non-fungible tokens of the present disclosure. The rule sets that define these tokens are embodied in the “smart contracts” itself. In an exemplary embodiment, tokenized IDs, for example, may be stored directly on a “smart contract.”

The term “user”, as used herein, may refer to a user of the platform, as taught herein, and include a fan, a consumer, a non-fungible token holder (e.g., owner or holder of the ticket to the live event).

While the platform taught herein may be used for creating a marketplace for ticketing (e.g., live event tickets), it can be appreciated that the systems, methods, and/or platform described herein may be configured to be used for any type of commerce requiring end-to-end control using a public blockchain. For example, the platform taught herein may be used to transact any product or service that can be digitally represented, anything that may require identification verification (e.g., biometrics, etc.), or any other rule-based commerce using blockchain protocols and smart contracts. Identification verification may include, but is not limited to, authentication of a user (e.g., fan) using the platform to determine if the user is a real human, and not a bot, or, separately to determine is a scalper.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

We claim:

1. A system for commerce in a distributed system with blockchain protocols and smart contracts, comprising:
an online platform for the electronic commerce of secure digital assets, wherein the secure digital assets are managed by the blockchain protocols and smart contracts;
a decentralized truth source;
an identity verification module; and
a payment verification module,
wherein the secure digital assets are securely redeemed using the blockchain protocols, and
wherein the secure redemption is based on a QR code.
